(19) United States
(12) Patent Application Publication
(10) Pub. No.: US 2026/0067150 A1
(43) Pub. Date: Mar. 5, 2026

(54) CARRIER FREQUENCY OFFSET TRACKER WITH MACHINE LEARNING CAPABILITIES

(71) Applicant: Cypress Semiconductor Corporation, San Jose, CA (US)

(72) Inventor: Nozhan HOSSEINI, Aliso Viejo, CA (US)

(73) Assignee: Cypress Semiconductor Corporation, San Jose, CA (US)

(21) Appl. No.: 18/821,645

(22) Filed: Aug. 30, 2024

(51) Int. Cl. H04L 27/26; G06N 20/00

(52) U.S. Cl. CPC H04L 27/2657; G06N 20/00

(57) ABSTRACT

Technologies related to tracking carrier frequency offset (CFO) are described. A predicted CFO estimate may be determined before receiving a packet. The predicted CFO estimate may be used to modulate a preamble of the packet based on the predicted CFO estimate. The corrected preamble is used to determine a current CFO estimate. A combination of the predicted CFO estimate and the previous CFO estimate is used to correct a portion of the next packet. The predicted CFO estimate functionality is contingent to the output from a machine learning model based on characteristics of the packet.

### BACKGROUND

Carrier Frequency Offset (CFO) is a parameter in wireless communication networks that refers to the difference between expected and actual carrier frequencies received by a receiver. This offset can arise due to various factors, such as frequency drifts caused by Doppler shifts, oscillator mismatches, or hardware imperfections. CFO can significantly impact the performance of communication systems. Effective estimation and compensation of CFO facilitate robust, reliable, and efficient communication of wireless communication networks.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a receiver with a carrier frequency offset (CFO) tracker and CFO prediction logic, according to one embodiment.

FIG. 2 illustrates a receive (RX) communication system with a CFO tracker and CFO prediction logic, according to one embodiment.

FIG. 3 illustrates an exemplary acquisition block of a receiver, according to one embodiment.

FIG. 4 is a flowchart illustrating operations of an RX chain with a CFO tracker and CFO prediction logic, according to one embodiment.

FIG. 5 is a flowchart illustrating operations of a receiver having a CFO tracker with input of CFO prediction logic, according to one embodiment.

FIG. 6 is a flowchart illustrating operations of a receiver with CFO prediction logic, according to one embodiment.

FIG. 7 illustrates an exemplary intrinsic distortion map, according to one embodiment.

FIG. 8 illustrates a neural network employed by the systems and methods of the present disclosure represented by a multilayer perceptron (MLP).

FIG. 9 illustrates a method of predicting CFO estimates of a receiver, according to one embodiment.

FIG. 10 illustrates a method of predicting CFO estimates of a receiver, according to one embodiment.

### DETAILED DESCRIPTION

Technologies related to tracking carrier frequency offset (CFO) are described. In wireless communication networks, receivers are often constrained by the extent to which they can accurately estimate Carrier Frequency Offset (CFO). This limitation arises due to various factors such as hardware constraints, signal-to-noise ratio, narrow digital filter band pass and processing capabilities. The hardware components within the receiver, such as the acquisition and digital signal processing units, may have inherent limitations in their ability to accurately estimate the CFO. This can introduce errors in the estimation process, thereby limiting the receiver's overall performance.

CFO estimation helps ensure the integrity and reliability of a received signal. Poor CFO estimation can lead to significant issues, particularly in the noise immersed, long range communication systems. In general, cascaded digital filters or Channel Selection Decimated Filter (CSDF) are designed to selectively filter the desired frequency band while attenuating unwanted signals and noise in noise immersed wireless communication systems. A noise immersed wireless communication system may by any wireless communication system that shares a frequency spectrum with other potentially interfering wireless communication systems. However, when CFO is large, the actual carrier frequency may deviate from the frequency band expected by the CSDF. This deviation can cause the CSDF to incorrectly align with the incoming signal's frequency band. Specifically, poor CFO estimation can result in a misalignment between the passband of the CSDF and the actual frequency of the incoming signal. Consequently, the CSDF may inadvertently cut off portions of the incoming signal that fall outside its incorrectly aligned passband. This may mislead any subsequent CFO estimation attempt, as accurate estimation of the CFO relies on a full energy presence of the incoming signal. This truncation of the incoming signal can lead to several detrimental effects on the communication system, including corrupting the incoming packet sent via the incoming signal. The integrity of the incoming packet can be compromised as essential information encoded in the cut-off signal portion is lost, which can render the incoming packet partially or wholly unusable. Additionally, this signal truncation can introduce inter-symbol interference (ISI), where the residual parts of the cut-off signal overlap with subsequent symbols. ISI can distort the original signal waveform, causing errors in symbol detection and decoding processes. This distortion further exacerbates the corruption of the incoming packet, as the receiver misinterprets the data, leading to erroneous outputs. Moreover, the loss of synchronization information due to signal truncation can disrupt the receiver's ability to maintain proper timing alignment with the transmitter. This misalignment can cause further degradation in the demodulation and decoding processes, resulting in a higher bit error rate (BER) and reduced overall communication system performance and worse overall reception quality.

Some wireless devices may use a first CFO estimation technique that includes estimating the CFO anew each time that a packet is received. This first CFO estimation technique may be referred to as a packet-based CFO estimator. However, the lack of continuous tracking can lead to overall inferior CFO estimation. Additionally, a packet-based estimator can be more susceptible to noise and interference present at the moment of packet reception. Because packet-based estimators do not have the benefit of averaging over a longer time period, transient noise or interference can significantly impact the accuracy of CFO estimation.

Other wireless devices may use a second CFO estimation technique that includes continuous tracking CFO estimation as packets are received and predicting the CFO of a next packet based on these historical CFO estimates. This second CFO estimation technique may be referred to as a CFO tracker. While a CFO tracker may be an overall better at CFO estimation than a packet-based estimator, in at least some cases, CFO trackers may poorly predict the CFO of the next packet if there is a sudden shift or change in the CFO. In these cases, a CFO tracker may perform worse than a packet-based CFO estimator. These sudden shifts or changes in CFO between packets may be referred to as CFO spikes. CFO spikes may be caused by a number of factors including, but not limited to, network channel switching (e.g., frequency hopping, such as in frequency-hopping spread spectrum (FHSS) systems), oscillator instability, interference and jamming, handovers in cellular networks, or hardware malfunctions.

Aspects and embodiments of the present disclosure overcome these deficiencies and others by providing a receiver with CFO prediction logic that predicts when a CFO inconsistency is to occur between a previous packet (e.g., packet N−1) and a next packet (e.g., packet N). This CFO prediction logic may output such a prediction that prevents historical CFO estimates from being used to predict the CFO of the next packet. If the CFO prediction logic does not predict a CFO inconsistency between the previous and next packets, a CFO tracker may use historical CFO estimates to predict the CFO of the next packet. By utilizing the CFO tracker, the present disclosure provides a superior solution to a packet-based estimator in most cases. By utilizing the CFO prediction logic, the present disclosure provides a packet-based CFO estimator when a CFO inconsistency is predicted. Thus, by providing a CFO tracker and CFO prediction logic, the present disclosure mitigates or eliminates the drawbacks associated with these CFO estimation techniques while leveraging their strengths during periods where they typically exhibit superior performance.

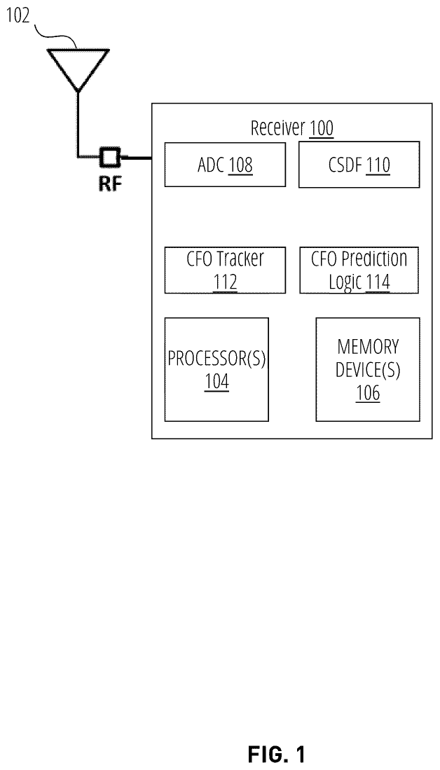

FIG. 1 illustrates a receiver 100 with a carrier frequency offset (CFO) tracker and CFO prediction logic, according to one embodiment. The receiver 100 may be part of a wireless device. The receiver 100 may be coupled to an antenna 102 that receives incoming signals from another wireless device over a network. This network may be a cellular network, a wireless local area network (WLAN), a wide area network (WAN), a personal area network (PAN), a metropolitan area network (MAN), a satellite communication network, a mesh network, a sensor network, an Internet of Things (IoT) network, a vehicular communication network, a cognitive radio network, a low-power wide-area network (LPWAN), a Bluetooth® network, a Zigbee® network, or any other type of wireless communication network.

The receiver 100 may include an analog-to-digital converter (ADC) 108. The ADC 108 may receive incoming signals received by the antenna 102 and convert them into digital signals. These digital signals may correspond to discrete data packets. These data packets may each have a preamble, an access address (AA), and a protocol data unit (PDU). The preamble is a sequence of bits at the beginning of the packet that helps the receiver 100 synchronize with the incoming signal, aiding in frequency synchronization efforts, such as CFO compensation, and timing alignment. Typically, the preamble is a simple and repetitive pattern, such as alternating 1s and 0s. In low energy Bluetooth® (BLE®), the preamble can be 8 bits long (i.e., one byte).

The AA is a unique identifier used to distinguish packets belonging to different connections or devices, ensuring that each particular packet is intended for the correct recipient. In BLE®, the access address can be 32 bits long. The AA can also help ensure that a packet is valid and properly synchronized in wireless communication systems. Each time the receiver 100 receives a packet, the receiver 100 checks the AA against an expected value. This expected value may be a specific address that the receiver 100 is programmed or configured to recognize as part of an established communication link or session. The expected value may be known to both a transmitter from which the packet is received and the receiver 100. If the AA matches the expected value, it indicates that the packet is intended for the receiver, validating its relevance.

The PDU is the main payload of the packet, containing the actual data being transmitted as well as additional control information necessary for communication. In BLE®, the PDU can vary in length and includes several fields, including: a header that contains control information such as packet type, length, and flags; a payload that contains the actual user data or control messages, with its length varying depending on the packet type and data being transmitted; and a Cyclic Redundancy Check (CRC) field at the end of the PDU to ensure data integrity by allowing the receiver to detect errors in the transmitted data.

The receiver 100 may include a channel selection decimation filter (CSDF) or any digital filter within receiver 110. The CSDF 110 may be a digital signal processing component designed to isolate and process specific frequency channels within a broader frequency spectrum. The CSDF 110 may operate by applying a series of mathematical algorithms and filtering techniques to incoming digital signals, effectively attenuating unwanted frequencies while providing a passband for target frequency channels. This selective filtering can help enable the receiver 100 to focus on relevant signals and reduce interference from adjacent channels. In some embodiments, the CSDF 110 can be dynamically configured to adapt to different frequency channels. In other embodiments, the CSDF 110 is a static filter that relies on upstream processes to bring incoming data to a baseband frequency. If CFO is present in the incoming signal, several different upstream processes may be used for CFO compensation, including but not limited to adjusting a local oscillator (LO) frequency, digital frequency correction, phase rotation correction (e.g., a Coordinate Rotation Digital Computer (CORDIC) process), or feedback control loops (e.g., Costas loops or second-order phase-locked loops (PLLs)).

The receiver 100 may include a CFO tracker 112. In some embodiments, the CFO tracker 112 continuously monitors and adjusts for frequency offsets between the transmitter and the receiver 100, which can occur due to LO mismatches, Doppler shifts, environmental changes, or the like. In one embodiment, the CFO tracker 112 may determine CFO estimates for received packets using a preamble-based estimation technique. This preamble-based estimation technique correlates the preamble of a received packet to a known reference, determines a correlation peak based on this correlation, and determines an CFO estimate based on this correlation peak. The CFO tracker 112 can compare the current and previous packet CFO estimates. Any difference between the CFO of the previous packet and the CFO of the current packet can directly correspond to the CFO estimate of the current packet. Thus, the CFO tracker 112 can impose the CFO estimate for the received packet (current packet) based on this difference as described herein.

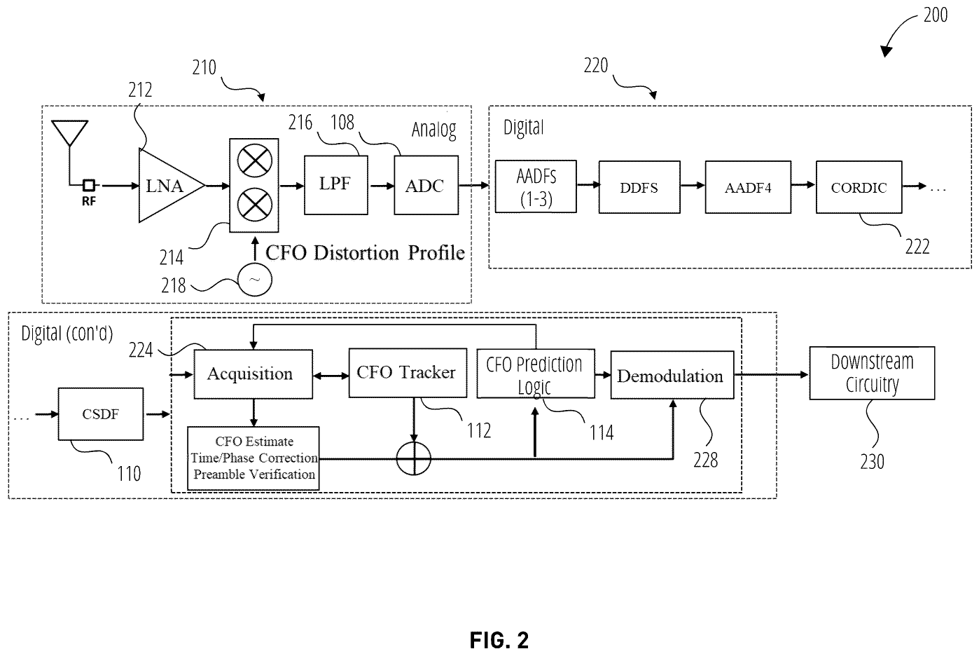

The CFO tracker 112 may use historical CFO estimates to calculate a predicted CFO estimate of a next packet. Each of these predicted CFO estimates may be represented by a value. In one embodiment, the CFO tracker 112 may use a CFO estimate of an immediately previous received packet to calculate the predicted CFO estimate. In another embodiment, the CFO tracker 112 may use multiple CFO estimates of recently received packets to calculate the predicted CFO estimate. Once this next packet is received, this predicted next CFO estimate may be used to correct frequency offset of the preamble of the received next packet before the preamble reaches the CSDF 110. For example, the receiver 100 can apply a phase rotation or frequency adjustment to the preamble based on the predicted CFO estimate. As another example, the receiver 100 can adjust the LO frequency based on the predicted CFO estimate. The operations of the CFO tracker 112 are described in more detail below in FIGS. 2-5.

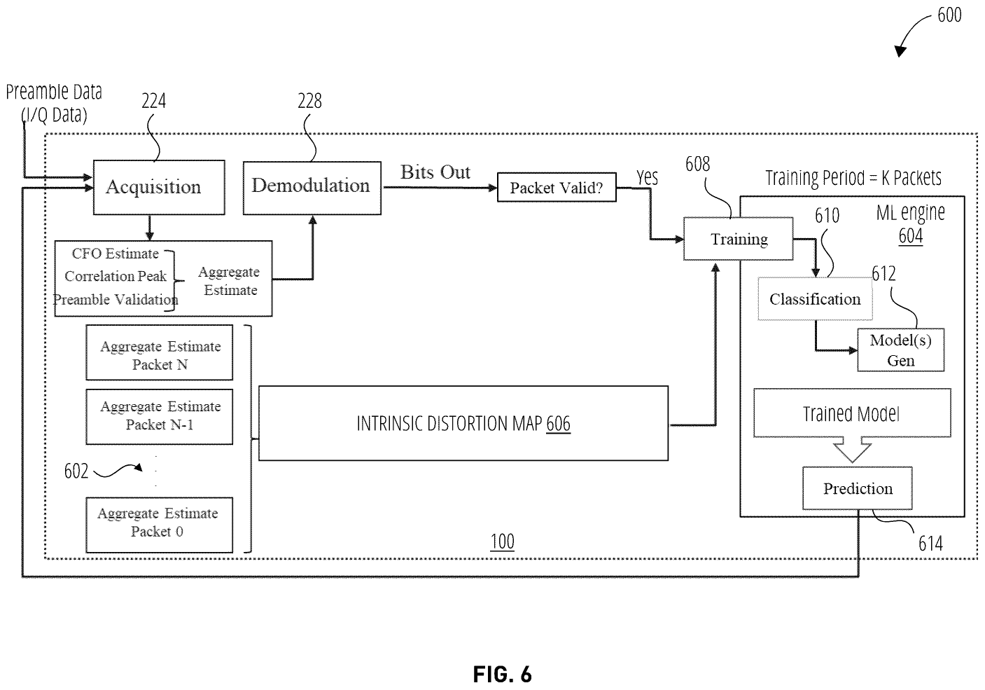

The receiver 100 may include CFO prediction logic 114. In some embodiment, the CFO prediction logic 114 may generate outputs that are indicative of a predicted inconsistency between sequential CFO estimates of consecutively received incoming packets. Throughout this document, we use the term “inconsistency” to refer to the Carrier Frequency Offset (CFO) behavior on a packet-by-packet basis that triggers a “failure” during the training period. In some embodiments, these “inconsistencies” may appear as large changes (e.g., spikes) between consecutive CFO estimates. In at least one embodiment, “failures” during the training period may refer to packets that fail to satisfy synchronization verification, as described herein. In at least one embodiment, the CFO prediction logic 114 may include a machine learning (ML) engine. In general, a ML engine is a software framework designed to automate the process of training and deploying machine learning models. Initially, the ML engine may utilize a training dataset to develop a model, often referred to as a machine learning model (MLM). During this training phase, the ML engine can apply various algorithms or techniques to learn patterns and relationships within the data, effectively optimizing the model's performance. Once trained, the model can be used to generate outputs by making predictions or decisions based on newly received data. Iteratively, refining the model so called incremental learning. Here, in at least one embodiment, the training phase of the CFO prediction logic 114 may expire once a certain number of packets (e.g., K packets, as illustrated in FIG. 6) have been received by the receiver 100. During this training phase, various characteristics about these packets may be used as training data to train the CFO prediction logic 114. These characteristics may include the CFO estimates, peak values of a delayed average correlation (e.g., CoRR Max), acquisition time delay estimates, preamble validation metrics, decoded access address validation metrics, or the like. These characteristics may be represented or organized into intrinsic distortion maps, such as the exemplary intrinsic distortion map 606 of FIG. 6. During training, the CFO prediction logic 114 is exposed to these characteristics and iteratively adjusts its internal parameters to minimize errors in its predictions. These adjustments are performed by algorithms that optimize the weights of the trained model of the CFO prediction logic 114 based on the input features and corresponding labels. Algorithms can include, but are not limited to, the following: K-Nearest Neighbors (KNN), Naive Bayes, Decision Trees, Random Forest, Gradient Descent, Stochastic Gradient Descent (SGD), Convolutional Neural Networks (CNN), Recurrent Neural Networks (RNN), and K-Means Clustering. The training of the CFO prediction logic 114 may be focused on identifying patterns within the training data that would lead the CFO prediction logic 114 to predict when a CFO inconsistency is likely to occur. Once trained, the CFO prediction logic 114 generates outputs that indicate whether a CFO inconsistency is predicted. Each output predicting a CFO inconsistency may be related to a possible failure of a next packet to satisfy the synchronization criteria. If the CFO prediction logic 114 predicts a CFO inconsistency, the output can reset the CFO tracker so that no historical CFO estimates are used to alter the preamble of the next packet before it passes through the CSDF 110. In other words, based on its output, the CFO prediction logic 114 can effectively cause the CFO tracker 112 to act like a packet-based CFO estimator. If the CFO prediction logic 114 does not predict a CFO inconsistency, then the CFO tracker 112 may perform under normal operating conditions by using historical CFO estimates to predict a next CFO estimate and correct the frequency offset of preamble of the next packet based on this predicted CFO estimate.

In at least one embodiment, the CFO prediction logic 114 may include a ML engine with incremental learning. Incremental learning is a machine learning technique where the model is updated continuously as new packets are received (i.e., new data becomes available). Unlike batch learning, which involves training a model on a finite dataset, incremental learning allows the model to learn and adapt to new information over time. In this embodiment, the CFO prediction logic 114 may continuously learn from the characteristics of incoming packets and provide better CFO inconsistency predictions. For example, in a scenario where a dwell time of a FHSS system changes (i.e., the duration between channel hops changes), the CFO prediction logic 114 having an incremental learning ML engine would allow the CFO prediction logic 114 to adapt to the new dwell time.

The receiver 100 may include one or more processor(s) 104. In some embodiments, the one or more processor(s) 104 may include any type of processing unit, such as central processing unit(s) (CPUs), graphics processing unit(s) (GPUs), a microcontroller(s), application-specific integrated circuit(s) (ASICs), or the like. In at least one embodiment, the one or more processor(s) 104 may include one or more logic processors, such as Arithmetic Logic Units (ALUs), Floating Point Units (FPUs), Digital Signal Processors (DSPs), Field Programmable Gate Arrays (FPGAs), or the like. Each of the processor(s) 104 may be operatively coupled to one or more of the memory device(s) 106. The processor(s) 104 may process the digital data generated by the ADC 108. The processor(s) 104 may execute one or more of the operations of the CFO tracker 112 or CFO prediction logic 114. In at least one embodiment, the processor(s) 104 execute one or more operations of the digital portions of the receiver, such as the CSDF 110 or any phase rotation correction processes (e.g., CORDIC). The processor(s) 104 may also decode received packets and convert them into a form usable by downstream circuitry, such as a host processor of the wireless device (not illustrated). The processor(s) 104 may also handle error correction, ensuring that the received data is reliable and accurate. The processor(s) 104 may also coordinate with other components of the receiver to manage tasks like signal synchronization, demodulation, and data formatting.

The receiver 100 may include one or more memory device(s) 106. The memory device(s) 106 may include random access memory (RAM), read-only memory (ROM), flash memory, electrically erasable programmable read-only memory (EEPROM), hard disk drives (HDDs, solid-state drives (SSDs), firmware, or any other suitable type of memory. The memory device(s) 106 may store instructions for hardware instructions of the receiver 100, configuration settings such as frequency channels, signal processing parameters, or user preferences, calibration data, signal processing algorithms, or the like. The memory device(s) 106 may also store model weights and parameters, metadata, or hyperparameters of the CFO prediction logic 114.

FIG. 2 illustrates a receive (RX) communication system 200 with a CFO tracker 112 and CFO prediction logic 114, according to one embodiment. The RX communication system 200 may be part of a receiver, such as the receiver 100 of FIG. 1. The RX communication system 200 may be split into an analog RX chain 210 and a digital RX chain 220. The digital RX chain 220 may be coupled to the analog RX chain 210 by the ADC 108. The digital RX chain 220 may include one or more of digital down conversion, digital filtering, decimation, demodulation, channel estimation or equalization, error correction, decoding, decryption, or data extraction and output formatting. Portions of the digital RX chain 220 may be implemented using digital signal processing (DSP) blocks or one or more processors, such as the processor(s) 104 of FIG. 1. The analog RX chain 210 and digital RX chain 220 may each include hardware, software, firmware, or a combination thereof.

In some embodiments, the analog RX chain 210 may include a low noise amplifier (LNA) 212, a low pass filter (LPF) 216, and the ADC 108. Incoming signals may be downconverted by a mixer 214 coupled to a local oscillator (LO) 218. In some cases, the frequency of the LO 218 may be mismatched with an LO of the transmitting device from which the incoming signals originate. In these cases, this mismatch can introduce CFO.

Once the ADC 108 converts the incoming signals into digital data, this data may be passed through one or more anti-aliasing decimation filters (AADFs) and a direct digital frequency synthesizer (DDFS). This digital data may then pass through phase rotation correction logic 222 that, based on a selected phase increment, correct the digital data. As described above, the phase increment of the phase rotation correction logic 222 may be at least partially based on an output of the CFO tracker 112. In at least one embodiment, this phase increment may be selected based on a center frequency of the CSDF 110. After the phase rotation correction logic 222, the digital data may pass through the CSDF 110, as described above with respect to FIG. 1.

After passing through the CSDF 110, the digital data may pass through an acquisition block 224. The acquisition block 224 can perform initial and continuous synchronization routines with incoming packets. The acquisition block 224 may scan a range of frequencies to detect the presence of an incoming packet. Once an incoming packet is detected, the acquisition block 224 can calculate a Carrier Frequency Offset (CFO) estimate representing any frequency discrepancies between the transmitter and receiver, ensuring that, when the incoming packet is demodulated, the receiver is aligned in frequency with the transmitter. The CFO estimate generated by the acquisition block 224 may be shared with the CFO tracker 112 and used to adjust the phase increment of the phase rotation correction logic 222. The acquisition block 224 can also address time and phase correction to synchronize the receiver's timing and phase with the incoming signal. This synchronization can involve adjusting an internal clock and phase settings of the receiver to match those of the transmitter. Additionally, the acquisition block 224 can determine a synchronization verification metric for the incoming packet to confirm correct reception. To determine this synchronization verification metric, the acquisition block 224 can correlate the incoming signal with known preamble sequences to verify the integrity and alignment of the incoming signal. One or more of the CFO estimate, time and phase correction information, and preamble verification metric may be shared with the CFO prediction logic 114.

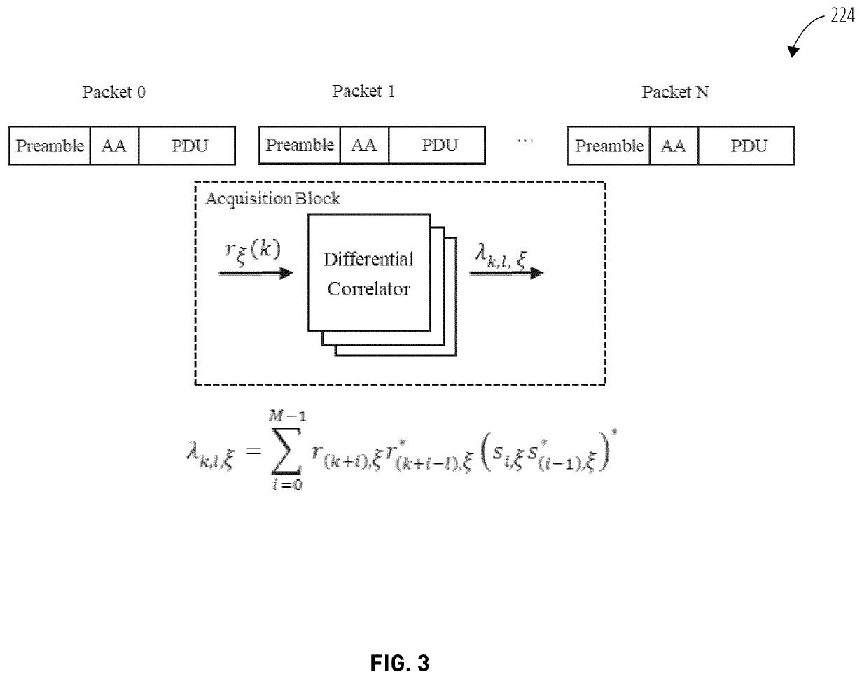

In some embodiments, the acquisition block 224 may include a differential correlator, as seen in FIG. 3. This differential correlator may scan the digital data for a known preamble sequence. By computing differences between consecutive symbols and correlating these with the expected preamble pattern, the acquisition block identifies the correct timing and frequency of the incoming signal. A peak correlation score calculated by the differential correlator indicates the presence of the preamble, which in turn can allow the acquisition block 224 to estimate the CFO and adjust the timing and phase settings of the receiver.

The CFO tracker 112 can continuously monitor and adjust for frequency offsets between the transmitter and the receiver 100, which can occur due to LO mismatches, Doppler shifts, environmental changes, or the like. In one embodiment, before receiving a particular incoming packet, the CFO tracker 112 may generate a predicted CFO estimate based on historical CFO estimates. These historical CFO estimates may be CFO estimates of one or more most recently received packets. In at least one embodiment, the predicted CFO estimate is based on a CFO estimate of a most recently received packet. In other words, the predicted CFO estimate may be determined using a last received CFO estimate from the acquisition block 224. This predicted CFO estimate may be used to select a phase increment of the phase rotation correction logic 222, which may be applied to digital data passed through the phase rotation correction logic 222 until (i) the acquisition block 224 calculates a new CFO estimate, or (ii) the CFO prediction logic 114 predicts an imminent CFO inconsistency. Upon the acquisition block 224 calculating a new CFO estimate (i.e., the preamble of the next incoming packet is received and processed by the acquisition block 224), the CFO tracker 112 may cause a new phase increment to be selected on the phase rotation correction logic 222 based on the new CFO estimate or a combination of the predicted CFO estimate and the new CFO estimate to digital data corresponding to the rest of the packet. If the CFO prediction logic 114 predicts an imminent CFO inconsistency, the CFO tracker 112 may cause a new phase increment to be selected on the phase rotation correction logic 222 based on negligent historic CFO or no CFO.

While the CFO prediction logic 114 is in training phase, one or more characteristics of a packet, such as the CFO estimate, time and phase correction information, and preamble verification metric, can be used as training data. After the training phase, these characteristics may be used in an input to the trained model of the CFO prediction logic 114. This trained model may generate an output based on these characteristics that is indicative of a predicted CFO inconsistency. In embodiments where the CFO prediction logic 114 implements an ML engine with incremental learning, characteristics of newly received packets may be used both as an input and to train to the model of the CFO prediction logic 114 each time that an incoming packet is received.

The RX communication system 200 may include a demodulation block 228. The demodulation block 228 can process the digital data to extract the original transmitted information. Upon receiving the digital data, the demodulator applies a series of signal processing techniques to decode the information. These techniques may include amplitude, frequency, or phase detection, depending on the modulation scheme employed, including but not limited to Amplitude Modulation (AM), Frequency Modulation (FM), or Phase Shift Keying (PSK). Additionally, the demodulation block 228 may utilize the CFO estimate provided by the acquisition block to refine its operations for fine tuning phase and frequency alignment to accurately reconstruct the original transmitted information. In at least one embodiment, the demodulation block 228 may utilize a combination of the predicted CFO estimate and the CFO estimate measured at the acquisition block 224 to correct the full incoming packet burst.

Once the digital data has been demodulated, downstream circuitry 230 may further process the digital data. This may include one or more of error detection and correction, decoding, decryption, de-interleaving, decompressing, packet reassembly, or application-specific processing.

FIG. 3 illustrates an exemplary acquisition block 224 of a receiver, according to one embodiment. This acquisition block 224 is meant to be exemplary and illustrate how an acquisition block 224 may determine CFO estimates. Assuming s_{ξ}(t) is the modulated signal of packet ξ, a received signal sampled at the receiver can be expressed as the following equation (1):

$${r}_{ξ} ( k ) = {s}_{ξ} ( k ) {e}^{j ( {ω}_{ξ} T \times k + {ϕ}_{ξ} )} + n ( k ) where n ( k ) \sim N ( 0 , {σ}^{2} ) \qquad Equation ( 1 )$$

In equation (1), Ω_{ξ} represents a frequency offset component (also referred to as CFO component) and φ_{ξ} represents a phase offset component. T is symbol duration, n(k) is the white Gaussian Noise with zero mean and standard deviation of σ at discrete time k. In a receiver where CFO estimates are performed on a per-packet basis, such as a packet-based CFO estimator, ω_{ξ} may represent the CFO estimate. However, if the receiver includes a CFO tracker 112 that predicts next CFO estimates based on historical CFO estimates, a received signal sampled at the receiver may be expressed as the following equation (2):

$${r}_{ξ} ( k ) = {s}_{ξ} ( k ) {e}^{j ( {\sum }_{ξ = 1}^{N} ( {ω}_{l , ξ} + {ω}_{l , ξ - 1} ) T \times k + {ϕ}_{ξ} )} + n ( k ) \qquad Equation ( 2 )$$

Using equation (2), any number of historical CFO estimates may be involved in the calculation of the CFO estimate of the current packet. ω_{l,ξ} represent frequency offset component after l previous packet CFO correction. In an embodiment where the CFO tracker 112 uses only the CFO estimate of an immediately previous packet to predict the CFO estimate of the current packet, the received signal sampled at the received may be expressed as the following equation (3):

$${r}_{ξ} ( k ) = {s}_{ξ} ( k ) {e}^{j ( ( {ω}_{l , ξ} + {ω}_{l , ξ - 1} ) T \times k + {ϕ}_{ξ}^{n} )} + n ( k ) \qquad Equation ( 3 )$$

Using equation (3), the CFO estimate of the current packet may be represented as the following equation (4):

$${ω}_{l , ξ} = {ω}_{ξ} - {ω}_{l , ξ - 1} or {ω}_{ξ} = {ω}_{l , ξ} + {ω}_{l , ξ - 1} \qquad Equation ( 4 )$$

Similarly using equation (3), the frequency offset estimation for the current packet ξ may be expressed as the following equation (5):

$${ω}_{l , ξ} = \frac{1}{T \times l} \times ∠ {λ}_{k , l , ξ} \qquad Equation ( 5 )$$

In at least one embodiment, λ_{k,l,ξ} is the output of a differential correlator of the acquisition block 224 with lag M. λ_{k,l,ξ}. The differential correlator can facilitate quasi-coherent detection of the preamble in most wireless communication systems. Additionally, the differential correlator can provide CFO estimation, depending on the number of lags (M) used. The differential correlator output may be expressed as the following equation (6):

$${λ}_{k , l , ξ} = {{\sum }_{i = 0}}^{M - 1} {r}_{( k - i ) , ξ} \times {{r}_{( k + i - l ) , ξ}^{*} ( {s}_{i , ξ} \times {s}_{( i - 1 ) , ξ}^{*} )}^{*} \qquad Equation ( 6 )$$

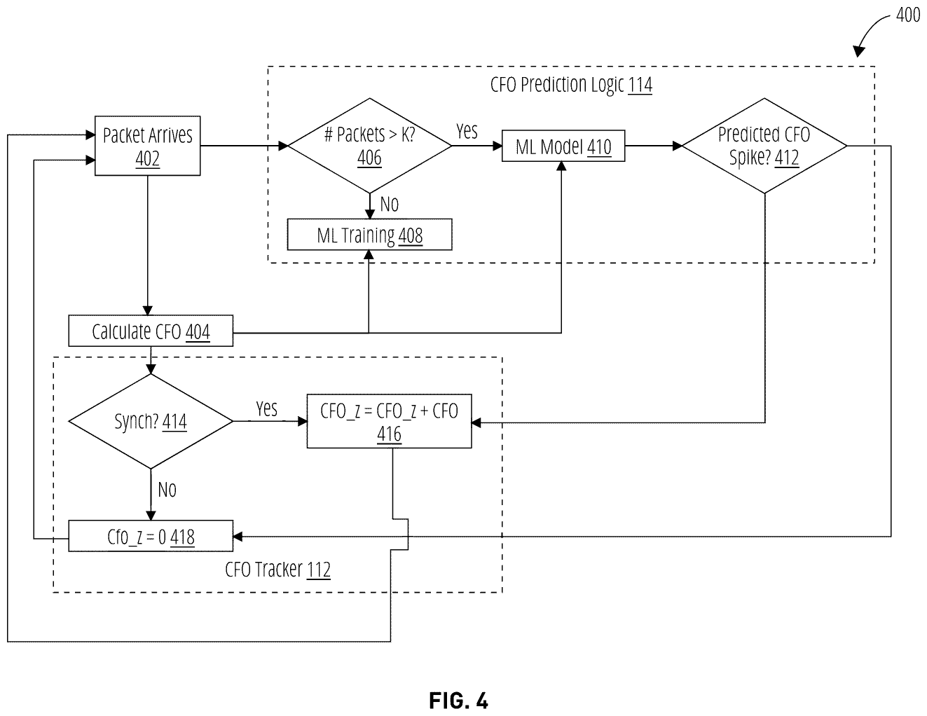

FIG. 4 is a flowchart 400 illustrating operations of a receiver with a CFO tracker 112 and CFO prediction logic 114, according to one embodiment. The operations of the flowchart 400 may be performed by processing logic that may comprise hardware (e.g., circuitry, dedicated logic, programmable logic, microcode, etc.), software, firmware, or a combination thereof. In one embodiment, the processing logic may be one or more components of the digital RX chain 220 of FIG. 2. The processing logic may include the one or more processor(s) 104 of FIG. 1. In some embodiments, the operations of the flowchart 400 may be performed by any combination of components of the receiver 100 of FIG. 1. The operations of the flowchart 400 can be performed by other devices described herein.

In some embodiments, blocks 406, 410, 412, 408 at least describe operations of the CFO prediction logic 114 and blocks 414, 416, 418 at least describe operations of the CFO tracker 112. In some embodiments, the CFO tracker 112 may also perform operations of block 404. In other embodiments an acquisition block of a receiver, such as the acquisition block 224 described here, may perform the operations of block 404.

At block 402, the processing logic receives a current packet. This current packet may be digitized by an ADC and pass through one or more data conditioning steps described herein, up to and including phase correction (e.g., by the phase rotation correction logic 222) and channel selection filtering (e.g., by the CSDF 110).

At block 404, the processing logic may calculate the CFO estimate of the current packet. In one embodiment, this CFO estimate may be calculated as described herein using the preamble of the current packet. In another embodiment, this CFO estimate may be calculated using a different suitable technique to calculate the CFO estimate. The CFO estimate calculated at block 404 may be used in combination with any previously predicted CFO estimate to modulate an AA portion and a PDU portion of the current packet.

At decision block 406, the processing logic determines if a model (e.g., an MLM) of an ML engine is still being trained. In at least one embodiment, the model is trained using characteristics of a predetermined number of initial packets received by the receiver. This predetermined number of initial packets may be represented by a variable K. Here, if less than K packets have been received by the receiver, then the model is still in training and the characteristics of the current packet are used to train the model at block 408. If at least K packets have been received by the receiver, then the model is no longer in training, and the characteristics of the current packet is used as an input of the model at block 410 to generate an output at decision block 412 that is indicative of the model predicting (or not predicting) a CFO inconsistency between the current packet and a next received packet.

In some embodiments, the processing logic may retrain the model each time that a new connection session is initialized. In some embodiments, the processing logic may train and store a model for each wireless device from which the receiver receives packets. In embodiments where the model is an incremental learning model, the decision block 406 may be unnecessary as characteristics from the current packet is used both for training (at block 408) and as an input to the model (at block 410).

At decision block 414, the processing logic may determine whether the current packet pass synchronization verification. The processing logic may determine whether current packet and receiver are synchronized via a preamble verification metric or a decoded access address verification metric.

At block 416, based on the outcome of decision block 414, the processing logic may set a next predicted CFO estimate of the CFO tracker 112. The predicted CFO may be represented by the variable CFO_z. This predicted CFO estimate may be a value. In some embodiments, this predicted CFO value may be used to adjust a phase increment of a phase rotation process or adjust a frequency of an LO of the receiver. In at least one embodiment, if the preamble verification metric indicates that the current packet is synchronized to the receiver and/or the access address validation metric indicates that the current packet is meant to be received by the receiver, the next predicted CFO estimate may be equal to the previous predicted CFO estimate in combination with the calculated CFO estimate of the current packet (e.g., CFO_z=CFO_z+CFO, as seen in the figure).

At block 418, if the preamble verification metric indicates that the current packet is not synchronized to the receiver (i.e., synchronization verification failure) and/or the access address validation metric indicates synchronization verification failure, the next predicted CFO estimate may be equal to zero. In other words, if the current packet is not synchronized to the receiver or the current packet is not meant to be received by the receiver, the predicted CFO estimate may be reset such that no historical CFO estimates of previous packets are used to predict a next CFO of the next packet.

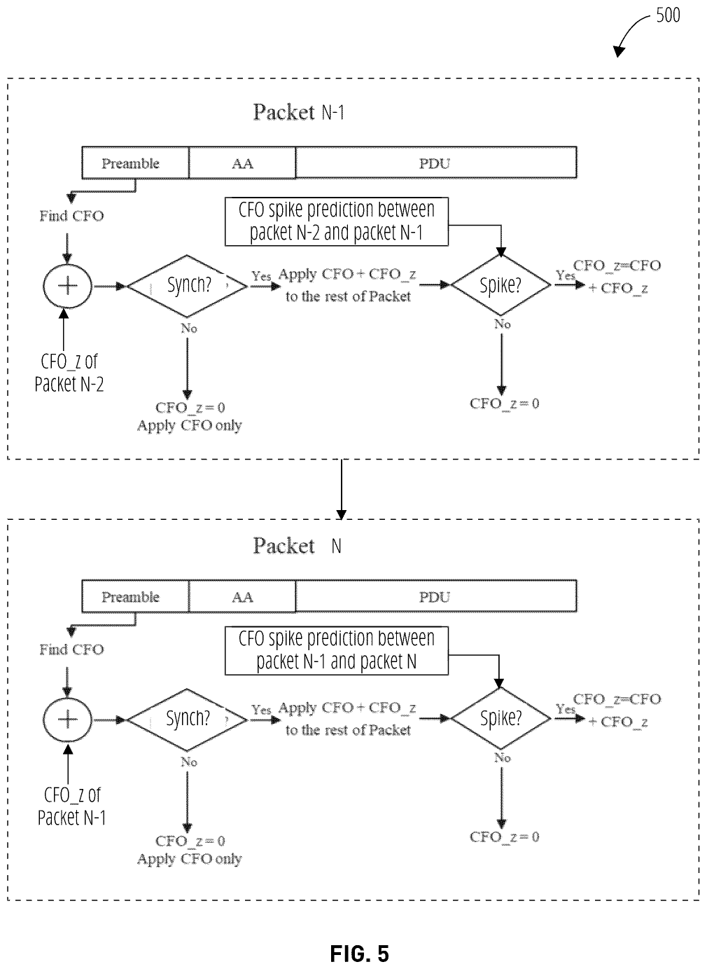

FIG. 5 is a flowchart 500 illustrating operations of a receiver having a CFO tracker 112 with input of CFO prediction logic 114, according to one embodiment. The operations of the flowchart 500 may be performed by processing logic that may comprise hardware (e.g., circuitry, dedicated logic, programmable logic, microcode, etc.), software, firmware, or a combination thereof. In one embodiment, the processing logic may be one or more components of the digital RX chain 220 of FIG. 2. The processing logic may include the one or more processor(s) 104 of FIG. 1. In some embodiments, the operations of the flowchart 500 may be performed by any combination of components of the receiver 100 of FIG. 1. The operations of the flowchart 500 can be performed by other devices described herein.

The flowchart 500 illustrates processes of the receiver receiving two consecutive (sequential) packets—packet N−1, and packet N. First, for packet N−1, the processing logic determines a first CFO estimate of the packet N−1. The first CFO estimate may be determined using processes or techniques described herein or by other suitable processes or techniques. The first CFO estimate is then combined with a second CFO estimate (CFO_z of packet N−2). This second CFO estimate may have also been used as a prediction of the overall CFO present within incoming signals corresponding to the packet N−1. The combination of the first and second CFO estimates may be referred to as a third CFO estimate. This third CFO estimate may be used to correct frequency of the digital data corresponding to the AA and PDU portions of the packet N−1 if the preamble verification metric indicates that the current packet is synchronized to the receiver and/or whether the access address validation metric indicates that the current packet is meant to be received by the receiver. If the preamble verification metric indicates that the current packet is not synchronized to the receiver and/or whether the access address validation metric indicates that the current packet is not meant to be received by the receiver, no CFO compensation technique may be implemented to modulate the digital data corresponding to the AA and PDU of portions of the packet N−1. In another embodiment, if the packet N−1 and the receiver are not synchronized, then the third CFO estimate may be set to equal the first CFO estimate.

If the third CFO estimate is used to modulate the AA and PDU portions of the packet N−1, the processing logic may determine whether the CFO prediction logic 114 has predicted a CFO inconsistency between overall CFOs of the consecutive packets N−1 and N. In other words, if the preamble verification metric indicates that the current packet is synchronized to the receiver and/or the access address validation metric indicates that the current packet is meant to be received by the receiver, the processing logic may determine whether the CFO prediction logic 114 has predicted a CFO inconsistency between overall CFOs of the consecutive packets N−1 and N. If the CFO prediction logic 114 has predicted an imminent CFO inconsistency between the consecutive packets, then a fourth CFO estimate may be set to reflect a negligent CFO or non-existent CFO, such as the value zero (e.g., CFO_z of packet N−1=0). If the CFO prediction logic 114 has not predicted an imminent CFO inconsistency between the consecutive packets, then the fourth CFO estimate may be set to equal the combination of the first and second CFO estimates. It can be equal weighted addition or any weighting algorithm preferred. In at least one embodiment, the second CFO estimate may be referred to as a predicted CFO estimate of packet N−2, while the fourth CFO estimate may be referred to a predicted CFO estimate of packet N−1. This fourth CFO estimate may be used to modulate the preamble portion of the following packet, which in this example is packet N.

For packet N, the processing logic determines a fifth CFO estimate of the packet N. The fifth CFO estimate may be determined using processes or techniques described herein or by other suitable processes or techniques. The fifth CFO estimate is then combined with the fourth CFO estimate (CFO_z of packet N−2). This fourth CFO estimate may have also been used as a prediction of the overall CFO present within incoming signals corresponding to the packet N. The combination of the fifth and fourth CFO estimates may be referred to as a sixth CFO estimate. This sixth CFO estimate may be used to correct frequency of the digital data corresponding to the AA and PDU portions of the packet N−1 if the preamble verification metric indicates that the current packet is synchronized to the receiver and/or whether the access address validation metric indicates that the current packet is meant to be received by the receiver. If the preamble verification metric indicates that the current packet is not synchronized to the receiver and/or whether the access address validation metric indicates that the current packet is not meant to be received by the receiver, no CFO compensation technique may be implemented to correct frequency offset of the digital data corresponding to the AA and PDU of portions of the packet N. In another embodiment, if the packet N and the receiver are not synchronized, then the sixth CFO estimate may be set to equal the fifth CFO estimate.

If the sixth CFO estimate is used to modulate the AA and PDU portions of the packet N, the processing logic may determine whether the CFO prediction logic 114 has predicted a CFO inconsistency between overall CFOs of consecutive packets N and N+1 (not illustrated). In other words, if the preamble verification metric indicates that the current packet is synchronized to the receiver and/or the access address validation metric indicates that the current packet is meant to be received by the receiver, the processing logic may determine whether the CFO prediction logic 114 has predicted a CFO inconsistency between overall CFOs of the consecutive packets N and N+1. If the CFO prediction logic 114 has predicted an imminent CFO inconsistency between these consecutive packets N and N+1, then a seventh CFO estimate may be set to reflect a negligent CFO or non-existent CFO, such as the value zero (e.g., CFO_z of packet N−1=0). If the CFO prediction logic 114 has not predicted an imminent CFO inconsistency between the consecutive packets N and N+1, then the seventh CFO estimate may be set to equal the combination of the fifth and fourth CFO estimates. In at least one embodiment, the seventh CFO estimate may be referred to a predicted CFO estimate of packet N. This seventh CFO estimate may be used to correct frequency offset of the preamble portion of the following packet, which in this example is packet N.

FIG. 6 is a flowchart 600 illustrating operations of a receiver with CFO prediction logic 114, according to one embodiment. The operations of the flowchart 500 may be performed by processing logic that may comprise hardware (e.g., circuitry, dedicated logic, programmable logic, microcode, etc.), software, firmware, or a combination thereof. In one embodiment, the processing logic may be one or more components of the digital RX chain 220 of FIG. 2. The processing logic may include the one or more processor(s) 104 of FIG. 1. In some embodiments, the operations of the flowchart 500 may be performed by any combination of components of the receiver 100 of FIG. 1. The operations of the flowchart 500 can be performed by other devices described herein.

Digital data corresponding to a current packet may be passed through the acquisition and demodulation blocks 224, 228, during which certain characteristics about the current packet may be calculated or otherwise determined. These characteristics may include a CFO estimate, correlation peaks, preamble validation metrics, AA validation metrics, or the like. After demodulation, the processing logic may determine whether the current packet is valid. This may be determined using AA validation techniques. Packet validation result (e.g., AA validation result) will be sent to the training block. In at least one embodiment, the CFO prediction logic 114 includes this ML engine 604. To determine how the characteristics of the packet should be used, the processing logic may determine whether the ML engine 604 is in a training mode or an operational mode. The ML engine 604 may be in training mode if less than a predetermined number of packets, K, have been received by the ML engine 604. If the ML engine 604 is in training mode, the characteristics of the current packet may be used as training data for a model of the ML engine 604. These characteristics may be used to generate an aggregate estimate packet 602 corresponding to the current packet. This aggregate estimate packet 602, along with all other aggregate estimate packets 602 corresponding to packets having characteristics used as training data, may be organized into intrinsic distortion maps 606 that are used to train the model of the ML engine 604. These aggregate estimate packs 602 may be used by the ML engine 604 to extract features related to predicting CFO inconsistency between consecutive packets.

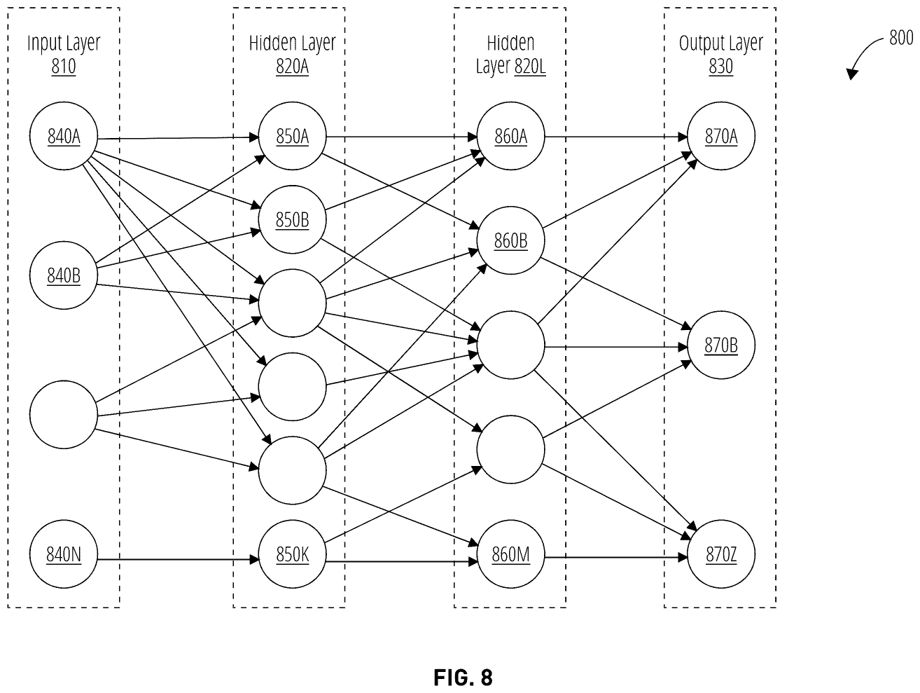

In some embodiments, the ML engine 604 may employ a model for performing the feature extraction. This model may be a neural network, such as a convolutional neural network (CNN) or a recurrent neural network (RNN). A neural network is a computational model that implements a multitude of connected nodes called “artificial neurons,” such that each artificial neuron processes one or more input signals (including a bias signal) and transmits the output signal to one or more neighboring artificial neurons. The output of an artificial neuron may be computed by applying its activation function to a linear combination of its inputs. A neural network may be trained by processing examples (“training data sets”) to perform feature extraction, regression and/or classification tasks, generally without being programmed with any task-specific rules, as described in more detail herein below. An example of such a model is provided below in FIG. 8.

If more than K packets have been received by the ML engine 604, the ML engine 604 is in an operational mode with a trained model, and the characteristics of the current packet may be used as an input to the trained model to generate a prediction output 614 indicative of whether an imminent CFO inconsistency is predicted (or not predicted) between the current packet and a next sequential packet. This prediction output 614 may be sent to the acquisition block 224 and also the CFO tracker 112 such that, if an imminent CFO inconsistency is predicted, a preamble of the next packet received is not modulated based on a predicted CFO estimate. In other words, if the prediction output 614 is indicative of an imminent CFO inconsistency, the prediction output 614 causes the CFO tracker 112 to act like a packet-based CFO estimator (i.e., no CFO estimate based on historical CFO estimates) instead of a CFO tracker (i.e., CFO estimate based on historical CFO estimate(s)).

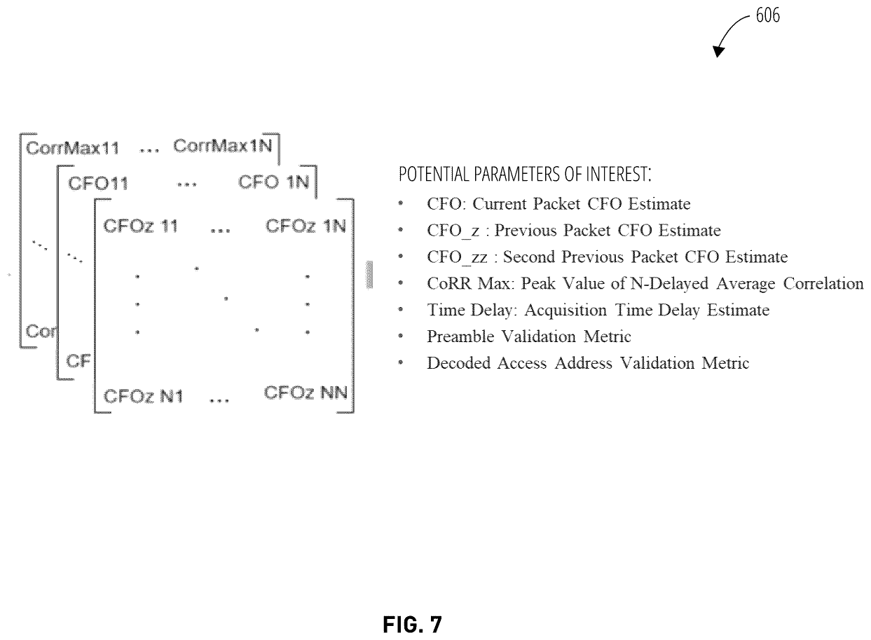

FIG. 7 illustrates an exemplary intrinsic distortion map 606, according to one embodiment. An intrinsic distortion map 606 in signal processing can be used quantify and/or visualize distortions or variations of different characteristics present between packets received by the receiver. These distortions or changes can result from various factors, including but not limited to noise, interference, or imperfections in the transmission medium and processing hardware. The intrinsic distortion map 606 can provide a quantitative measure of these distortions or changes between packets. In at least one embodiment, each characteristic of packets may be assigned a different intrinsic distortion map 606. The systems, processes, operations, and methods described herein may include one or more intrinsic distortion maps 606 for various characteristics of each packet used for training, including but not limited to one or more of (i) a current packet CFO estimate (packet N), (ii) a previous packet CFO estimate (packet N−1, CFO_z), (iii) a second previous packet CFO estimate (packet N−2, CFO_zz), (iv) peak correlations derived by the acquisition block 224 (CoRR Max), (v) acquisition time delay estimates, (vi) preamble validation metrics, or (vii) decoded access address validation metrics.

FIG. 8 illustrates a neural network employable by the systems and methods of the present disclosure represented by a multilayer perceptron (MLP) 800. The MLP 800 can include the artificial neurons grouped into several layers, including the input layer 810, one or more hidden layers 820A-820L, and the output layer 830. The input layer 810 includes one or more neurons 840A-840N, which are connected to one or more neurons 850A-850K of the first hidden layer 820A. The first hidden layer neurons 850A-850K are, in turn, connected to one or more neurons 860A-860M of the second hidden layer 820L. The second hidden layer neurons 860A-860M are, in turn, connected to one or more neurons 870A-870Z of the output layer 830. At least some of the nodes of the artificial neural network represented by the MLP 800 may utilize nonlinear activation functions, while the remaining nodes (e.g., the nodes of the output layer) may utilize linear activation functions. While FIG. 8 schematically illustrates a two hidden layers 820A and 820L, in various implementations of the systems and methods of the present disclosure the number of hidden layers may vary. In some embodiments, the number of hidden layers is a hyperparameter of the model, i.e., a parameter, the value of which is specified before the training process. Other hyperparameters of the model may include the numbers of nodes in each layer, the activation function types, etc.

Each edge in FIG. 8 denotes a connection for transmitting a signal from one artificial neuron to another, in a manner similar to operation of the synapses in the human brain. Edge weights, which increase or attenuate the signals being transmitted through respective connections, are defined at the network training stage based on a training dataset that includes a plurality of labeled inputs (i.e., inputs with known classification).

The neural network training procedure may start with initializing all edge weights and neuron bias values to random or predetermined values. The forward propagation involves sequentially processing, by the neural network, the labeled data items of the training dataset (e.g., current or historical packet CFO estimates, peak correlations, acquisition time delay estimates, preamble validation metrics, decoded access address validation metrics, or the like). The observed output of the neural network is compared with the desired output specified by the label associated with the vector being processed, and the error is propagated back to the previous layers of the neural network, in which the weights and bias values are adjusted to minimize the predetermined loss function (e.g., the difference between the observed output and the desired output specified by the label). This process may be repeated until the output error would fall below a predetermined threshold, or until the neural network has otherwise completed a training phase.

Furthermore, because incoming packets are received sequentially, systems and methods of the present disclosure may employ recurrent neural networks (RNN) for sequentially processing batches of raw data in real time. An RNN is capable of maintaining its state, which reflects the information about the inputs which have been previously processed by the network. The RNN would take the state information into account for processing each subsequent input. In other words, the network output is defined not only by the current input, but also by the inputs that have been previously processed by the network.

The neural networks utilized by the systems and methods of the present disclosure may be deployed on the hardware having limited computational capacity and/or available memory (such as mobile or wearable devices), since the raw data reflecting thousands of measurement points would be processed sequentially, and each batch of raw data may be discarded after having been processed by the neural network, since the internal state of the neural network stores the necessary information extracted from the input data processed by the network.

Notwithstanding the above description of FIG. 8, systems and methods of the present disclosure may be implemented by other model types other than neural networks, such as a K-Nearest Neighbors (KNN) model, a Naive Bayes model, one or more decision tree models, a random forest model, a gradient descent model, a Stochastic Gradient Descent (SGD) model, one or more convolutional Neural Network (CNN) models, a K-Means Clustering model, or any other type of suitable model.

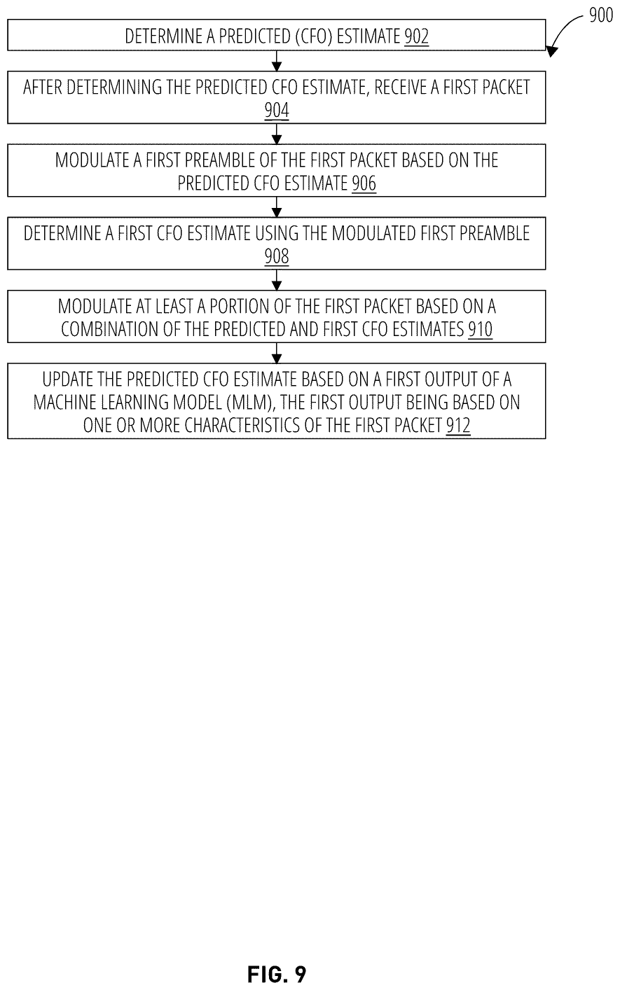

FIG. 9 illustrates a method 900 of predicting CFO estimates of a receiver, according to one embodiment. The method 900 may be performed by processing logic that may comprise hardware (e.g., circuitry, dedicated logic, programmable logic, microcode, etc.), software, firmware, or a combination thereof. In one embodiment, the processing logic may include one or more components of the digital RX chain 220 or the analog RX chain 210 of FIG. 2. The processing logic may include the one or more processor(s) 104 of FIG. 1. In some embodiments, the method 900 may be performed by the receiver 100 of FIG. 1. The method 900 can be performed by other devices described herein.

At block 902, the processing logic may determine a predicted (CFO) estimate.

At block 904, the processing logic may receive a first packet after determining the predicted CFO estimate.

At block 906, the processing logic may modulate a first preamble of the first packet based on the predicted CFO estimate.

At block 908, the processing logic may determine a first CFO estimate using the modulated first preamble.

At block 910, the processing logic may modulate at least a portion of the first packet based on a combination of the predicted CFO estimate and the first CFO estimate.

At block 912, the processing logic may update the predicted CFO estimate based on a first output of a machine learning model (MLM), the first output being based on one or more characteristics of the first packet.

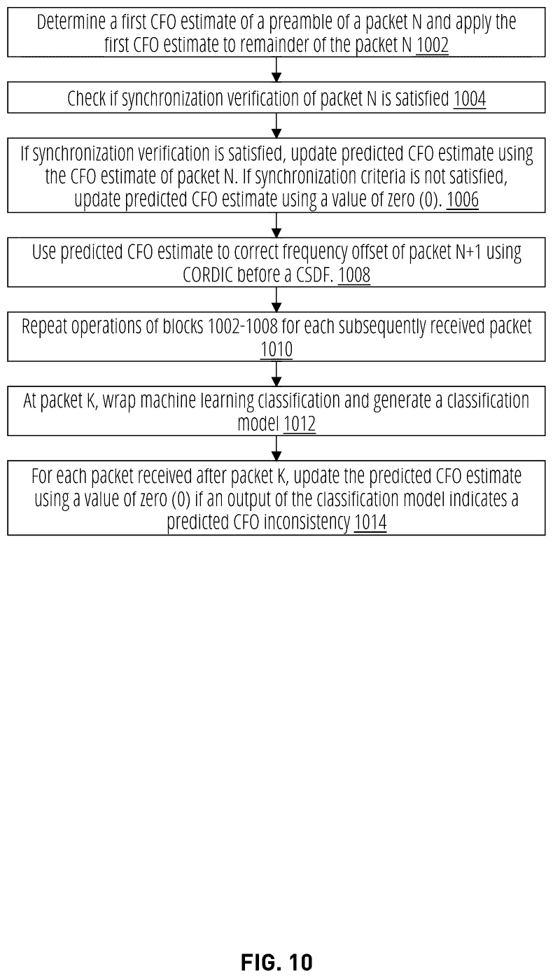

FIG. 10 illustrates a method 1000 of predicting CFO estimates of a receiver, according to one embodiment. The method 1000 may be performed by processing logic that may comprise hardware (e.g., circuitry, dedicated logic, programmable logic, microcode, etc.), software, firmware, or a combination thereof. In one embodiment, the processing logic may include one or more components of the digital RX chain 220 or the analog RX chain 210 of FIG. 2. The processing logic may include the one or more processor(s) 104 of FIG. 1. In some embodiments, the method 1000 may be performed by the receiver 100 of FIG. 1. The method 1000 can be performed by other devices described herein.

At block 1002, the processing logic may determine a first CFO estimate of a preamble of a packet N and apply the first CFO estimate to remainder of the packet N.

At block 1004, the processing logic may check if synchronization verification of packet N is satisfied.

At block 1006, the processing logic may perform one of two updates to a predicted CFO estimate. If synchronization verification is satisfied, the processing logic may update the predicted CFO estimate using the CFO estimate of packet N. If synchronization criteria is not satisfied, the processing logic may update the predicted CFO estimate using a value of zero (0).

At block 1008, the processing logic may use the predicted CFO estimate to correct frequency offset of packet N+1 using CORDIC before a CSDF. Packet N+1 may be received directly after packet N.

At block 1010, the processing logic may repeat operations of blocks 1002-1008 for each subsequently received packet.

At block 1012, the processing logic may wrap machine learning classification and generate a classification model after a predetermined number of packets K have been received or processed by the receiver. In at least one embodiment, the generated classification model may be embedded within a CFO tracker system that performs one or more operations of blocks 1002-1008.

At block 1014, for each packet received after the classification model has been generated, the processing logic may update the predicted CFO estimate using a value of zero (0) if an output of the classification model indicates a predicted CFO inconsistency.

In the above description, numerous details are set forth. It will be apparent, however, to one of ordinary skill in the art having the benefit of this disclosure, that embodiments of the present disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “detecting,” “comparing,” “resetting,” “adding,” “calculating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Embodiments descried herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMS, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that the above description is intended to be illustrative and not restrictive. Many other embodiments will be apparent to those of skill in the art upon reading and understanding the above description. The scope of the embodiments should, therefore, be determined with reference to the appended claims, along with the full scope of equivalents to which such claims are entitled.

What is claimed is:

1. A method comprising:
determining a predicted (CFO) estimate;
after determining the predicted CFO estimate, receiving a first packet;
correcting frequency offset of a first preamble of the first packet based on the predicted CFO estimate;
determining a first CFO estimate using the corrected first preamble;
correcting frequency offset of at least a portion of the first packet based on a combination of the predicted CFO estimate and the first CFO estimate; and
updating the predicted CFO estimate based on a first output of a machine learning model (MLM), the first output being based on one or more characteristics of the first packet.

2. The method of claim 1, wherein the predicted CFO estimate after being updated based on the first output is a combination of the predicted CFO estimate and the first CFO estimate, and wherein the method further comprises:
after updating the predicted CFO estimate based on the first output, receiving a second packet;
correcting offset frequency of a second preamble of the second packet based on the predicted CFO estimate;
determining a second CFO estimate using the corrected second preamble;
correcting offset frequency of at least a portion of the second packet based on a combination of the predicted CFO estimate and the second CFO estimate; and
updating the predicted CFO estimate based on a second output of the MLM, the second output being based on one or more characteristics of the second packet.

3. The method of claim 1, wherein the first output of the MLM is indicative of a CFO inconsistency between the first packet and a second packet following the first packet, wherein the predicted CFO estimate after being updated based on the first output represents a negligent CFO or non-existent CFO, and wherein the method further comprises:
after updating the predicted CFO estimate based on the first output, receiving the second packet;
determining a second CFO estimate using a second preamble of the second packet;
correcting frequency offset of at least a portion of the second packet based on the second CFO estimate; and
updating the predicted CFO estimate based on a second output of the MLM, the second output being based on one or more characteristics of the second packet.

4. The method of claim 3, wherein the second output of the MLM is not indicative of a CFO inconsistency between the second packet and a third packet following the second packet, wherein the predicted CFO estimate after being updated based on the second output is equal to the second CFO estimate, and wherein the method further comprises:
after updating the predicted CFO estimate based on the second output, receiving a third packet;
correcting frequency offset of a second preamble of the third packet based on the predicted CFO estimate;
determining a third CFO estimate using the corrected second preamble;
correcting frequency offset of at least a portion of the third packet based on a combination of the predicted CFO estimate and the second CFO estimate; and
updating the predicted CFO estimate based on a third output of the MLM, the third output being based on one or more characteristics of the third packet.

5. The method of claim 1, wherein correcting frequency offset of at least the portion of the first packet based on a combination of the predicted CFO estimate and the first CFO estimate comprises:
selecting a phase increment based on a combination of the predicted CFO estimate and the first CFO estimate; and
processing the portion of the first packet using a phase rotation correction process using the selected phase increment.

6. The method of claim 5, wherein the phase increment is selected based on a center frequency of a channel selection decimation filter (CSDF).

7. The method of claim 1, wherein the one or more characteristics of the first packet comprises a plurality of a current packet CFO estimate, one or more historical CFO estimates, a peak correlation, an acquisition time delay estimate, a preamble validation metric, or a decoded access address validation metric.

8. The method of claim 1, further comprising:
before receiving the first packet, receiving a predetermined number of packets; and
training, based on characteristics of the predetermined number of packets, the MLM.

9. A receiver comprising:
a receive (RX) chain to receive incoming signals over a network, the RX chain comprising an analog-to-digital converter (ADC);
memory; and
one or more processors operatively coupled to the memory, the one or more processors to process digital data generated by the ADC, wherein the receiver is to:
determine a predicted (CFO) estimate;
after determining the predicted CFO estimate, receive a first packet;
correct CFO of a first preamble of the first packet based on the predicted CFO estimate;
determine a first CFO estimate using the corrected first preamble;
correct frequency offset of at least a portion of the first packet based on a combination of the predicted CFO estimate and the first CFO estimate; and
update the predicted CFO estimate based on a first output of a machine learning model (MLM), the first output being based on one or more characteristics of the first packet.

10. The receiver of claim 9, wherein the predicted CFO estimate after being updated based on the first output is a combination of the predicted CFO estimate and the first CFO estimate, and wherein the receiver is further to:
after updating the predicted CFO estimate based on the first output, receive a second packet;
correct frequency offset of a second preamble of the second packet based on the predicted CFO estimate;
determine a second CFO estimate using the corrected second preamble;
correct frequency offset of at least a portion of the second packet based on a combination of the predicted CFO estimate and the second CFO estimate; and
update the predicted CFO estimate based on a second output of the MLM, the second output being based on one or more characteristics of the second packet.

11. The receiver of claim 9, wherein the first output of the MLM is indicative of a CFO inconsistency between the first packet and a second packet following the first packet, wherein the predicted CFO estimate after being updated based on the first output represents a negligent CFO or non-existent CFO, and wherein the receiver is further to:
after updating the predicted CFO estimate based on the first output, receive a second packet;
determining a second CFO estimate using a second preamble of the second packet;
correct frequency offset of at least a portion of the second packet based on the second CFO estimate; and
updating the predicted CFO estimate based on a second output of the MLM, the second output being based on one or more characteristics of the second packet.

12. The receiver of claim 11, wherein the second output of the MLM is not indicative of a CFO inconsistency between the second packet and a third packet following the second packet, wherein the predicted CFO estimate after being updated based on the second output is equal to the second CFO estimate, and wherein the receiver is further to:
after updating the predicted CFO estimate based on the second output, receive a third packet;
correct frequency offset of a third preamble of the third packet based on the predicted CFO estimate;
determine a third CFO estimate using the corrected third preamble;
correct the frequency offset of at least a portion of the third packet based on a combination of the predicted CFO estimate and the second CFO estimate; and
update the predicted CFO estimate based on a third output of the MLM, the third output being based on one or more characteristics of the third packet.

13. The receiver of claim 9, wherein to correct the portion of the first packet based on a combination of the predicted CFO estimate and the first CFO estimate, the receiver is to:
select a phase increment based on a combination of the predicted CFO estimate and the first CFO estimate; and
process the portion of the first packet using a phase rotation correction process using the selected phase increment.

14. The receiver of claim 13, wherein the phase increment is selected based on a center frequency of a channel selection digital filter (CSDF).

15. The receiver of claim 9, wherein the one or more characteristics of the first packet comprises a plurality of a current packet CFO estimate, one or more historical CFO estimates, a peak correlation, an acquisition time delay estimate, a preamble validation metric, or a decoded access address validation metric.

16. The receiver of claim 9, wherein the receiver is further to:
before receiving the first packet, receiving a predetermined number of packets; and
training, based on characteristics of the predetermined number of packets, the MLM.

17. A wireless device, comprising:
a receive (RX) chain to receive incoming signals over a network, the RX chain comprising an analog-to-digital converter (ADC);
memory; and
one or more processors operatively coupled to the memory, the one or more processors to process digital data generated by the ADC, wherein the one or more processors are to:
track carrier frequency offset (CFO) values of a first plurality of packets received over the network;
train, using characteristics of the first plurality of packets received from a second wireless device, a machine learning model (MLM), wherein the MLM is to predict CFO spikes between consecutively received packets;
receive, after the first plurality of packets, a first packet over a first channel of the network; and
based on one or more characteristics of the first packet, generate an output, via the MLM, indicative of a CFO inconsistency between the first packet and a second packet following the first packet.

18. The wireless device of claim 17, wherein the characteristics of the first plurality of packets comprises a plurality of a current packet CFO estimate, one or more historical CFO estimates, a peak correlation, an acquisition time delay estimate, a preamble validation metric, or a decoded access address validation metric.

19. The wireless device of claim 17, wherein the one or more characteristics of the first packet comprises a one or more of a current packet CFO estimate, one or more historical CFO estimates, a peak correlation, an acquisition time delay estimate, a preamble validation metric, or a decoded access address validation metric.

20. The wireless device of claim 17, wherein the output causes the wireless device to modulate a preamble of the second packet without CFO compensation based on historical CFO estimates.
